(19) United States
(12) Patent Application Publication
(10) Pub. No.: US 2022/0095046 A1
(43) Pub. Date: Mar. 24, 2022

(54) HYBRID IN-CAR SPEAKER AND HEADPHONE BASED ACOUSTICAL AUGMENTED REALITY SYSTEM

(71) Applicant: HARMAN INTERNATIONAL INDUSTRIES, INCORPORATED, Stamford, CT (US)

(72) Inventors: Riley WINTON, Opelika, AL (US); Christopher LUDWIG, Bloomfield Hills, MI (US)

(73) Assignee: HARMAN INTERNATIONAL INDUSTRIES, INCORPORATED, Stamford, CT (US)

(21) Appl. No.: 17/420,323

(22) PCT Filed: Jan. 2, 2020
(86) PCT No.: PCT/US2020/012039

§ 371 Date: Jul. 1, 2021

Related U.S. Application Data
(60) Provisional application No. 62/787,981, filed on Jan. 3, 2019.

(51) Int. Cl. H04R 3/00; H04R 3/02

(52) U.S. Cl. CPC H04R 3/005; H04R 2499/13; H04R 3/02

(57) ABSTRACT

An in-car headphone system may include a first headset associated with a vehicle occupant and configured to transmit audio signals to an associated occupant; at least one interior microphone configured to receive an interior audio signal from within a vehicle cabin; at least one exterior microphone configured to receive an exterior audio signal acquired from outside of the vehicle; and a processor configured to receive at least one of the interior audio signal from the at least one interior microphone and the exterior audio signal from the at least one exterior microphone; determine whether at least one of the interior audio signal and exterior audio signal include a trigger command or an alert signal; and transmit the audio signal that includes the trigger command or alert signal to the first headset in response to the audio signals including a trigger command or an alert signal.

### CROSS-REFERENCE TO RELATED APPLICATIONS

This application claims the benefit of U.S. provisional application Ser. No. 62/787,981 filed Jan. 3, 2020, the disclosure of which is hereby incorporated in its entirety by reference herein.

### TECHNICAL FIELD

Disclosed herein are hybrid in-car speaker and headphone based acoustical augmented reality systems.

### BACKGROUND

Vehicles are often equipped with various infotainment systems including vehicle radio, screens for viewing movies, headphones, spatial audio systems, etc. Often vehicles carry multiple occupants, each wishing to use a different infotainment system. However, existing loudspeaker technology within the vehicle may prevent the separation of content between the various occupants.

### SUMMARY

An in-car audio system may include at least one interior microphone configured to receive an interior audio signal from within a vehicle cabin; at least one vehicle speaker arranged in a vehicle cabin and configured to transmit audio signals to a driver; at least one first headset associated with a vehicle occupant and configured to transmit audio signals to an associated occupant; at least one exterior microphone configured to receive an exterior audio signal acquired from outside of the vehicle; and a processor programmed to receive the interior audio signal from the at least one interior microphone and the exterior audio signal from the at least one exterior microphone; transmit the interior audio signal to the at least one vehicle speaker and the at least one interior microphone to facilitate a conversation between the driver and at least one occupant; determine whether the exterior audio signal includes an alert signal; and cease transmission of the interior audio signal to the vehicle speaker and transmit the alert signal to the vehicle speaker in response to exterior audio signal including a an alert signal.

An in-car audio system may include a first headset associated with a first vehicle occupant and configured to transmit audio signals to the first vehicle occupant; at least one exterior microphone configured to receive an exterior audio signal acquired from outside of the vehicle; at least one vehicle speaker configured to transmit audio signals; and a processor programmed to transmit interior audio signals acquired from within the vehicle to at least one vehicle speaker; receive the exterior audio signal from the at least one exterior microphone; determine whether the exterior audio signal include an alert signal; and interrupt the interior audio signals at the vehicle speakers to transmit the exterior audio signal in response to the exterior audio signal including the alert signal.

An in-car audio method may include receiving an interior audio signal from at least one interior microphone; receiving at least one trigger command including an identification of which of a subset of a plurality of headsets and speakers to transmit the interior audio signal to, each of the headsets and speakers associated with a vehicle occupant; and transmitting the interior audio signal to the subset of headsets and speakers in response to the trigger command, wherein at least one of the subset of headset and speakers is an in-vehicle speaker.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example video audio system for a vehicle;

FIG. 2 illustrates an example block diagram of the audio system of FIG. 1;

FIG. 3 illustrates an example process for the audio system where an exterior sound may interrupt the driver's current content;

FIG. 4 illustrates an example process for the audio system where an interior sound may interrupt one of the occupant's current content;

FIG. 5 illustrates an alternative view of the system of FIG. 1;

FIG. 6 illustrates an alternative view of the system of FIG. 1; and

FIG. 7 illustrates an alternative view of the system of FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is an audio system for a vehicle that includes a network of internally facing car cabin microphones and externally facing car environment microphones to provide an acoustical augmented reality system for enhanced communication and increased awareness for environmental factors. The system may include a number or array of microphones inside the vehicle to capture speech. Approximately one microphone or microphone array per occupant seat may be included. The external microphones may capture a significant acoustic signature from the external environment. Each passenger may have a pair of personal headphones. The driver may enjoy audio via the vehicle speakers. The vehicles human machine interface (HMI) or audio processing unit may control the user inputs and preferences and map the microphone signals to the various headphone and microphone outputs.

The system may also include an adaptive system for detecting emergency sound signatures (e.g., ambulance sirens) to aid the driver in awareness and cognitive driving tasks. The system may increase driver awareness of external events such as playing back real-time environmental sound for accident avoidance and increased awareness. The system may also allow for private conversations between two occupants, personalized media for each occupant, and parent monitoring of conversations for each occupant. The system may layer these features and provide for a flexible and robust system that handles many types of user interactions. The system may further allow for a higher-performance audio system comparable to the present industry best and the system may be completely optimized for driver seat optimization. This may allow the system to provide the driver with the best listening experience as opposed to decent tuning in all seats.

While the driver listens to the vehicle speakers, the remaining passengers may wear headphones to create private sound zones with media and content of each passenger's choosing. Typical vehicle audio systems may rely on standard loudspeaker technology to distribute acoustic energy through the entire cabin. This may prevent the separation of content between different occupants. Headphones may help solve this issue, but may also prevent external sounds from being recognized. Further, headphones may prevent natural speech among the occupants.

With the disclosed system, because each passenger is relying on passive acoustic separation via headphones, performance expectations may be vastly superior when compared to the latest technological ‘active controller’ solutions such as individual sound zones (ISZ). With in-car communications (ICC), passengers may still engage in very natural conversation, even though they are acoustically separated. Since the driver is using the existing speaker system, the common expertise of car tuning and system architecture design can be fully utilized, and a vast, spacious sound experience can still be achieved for the driver. A certain amount of “bleed” from the driver's audio content may leak through other passenger's headphones. To negate some of this, an integrated noise cancellation algorithm may be included and reduce the low-frequency propagation in all passenger seats. Thus, the headphones will provide a great degree of passive contrast (cancellation) to all mid and high frequencies, and the system may cancel out the low-frequencies at a more targeted rate. The system offers more freedom thus providing better, more robust separation between passengers' sound zones, ultimately providing all passengers with a much cleaner, distraction free, listening experience.

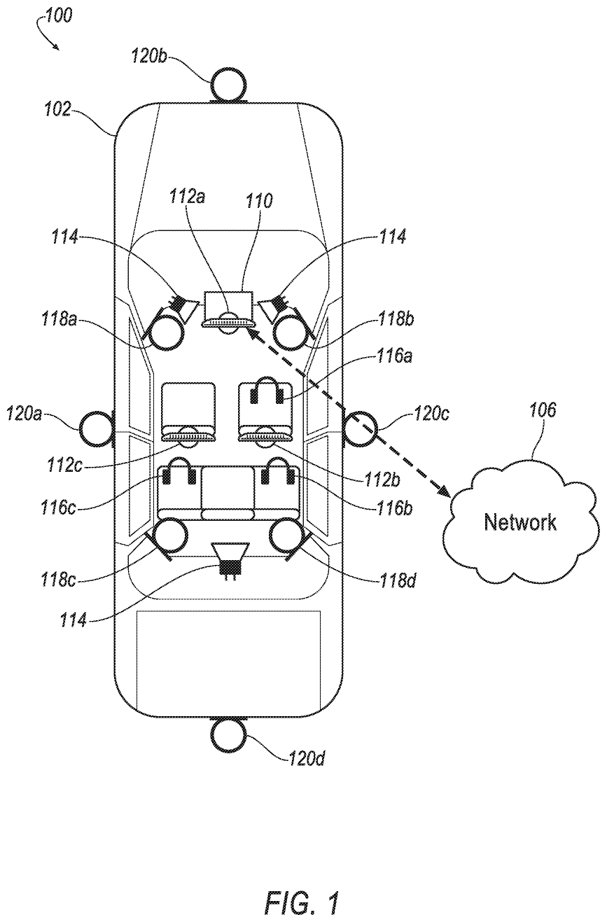

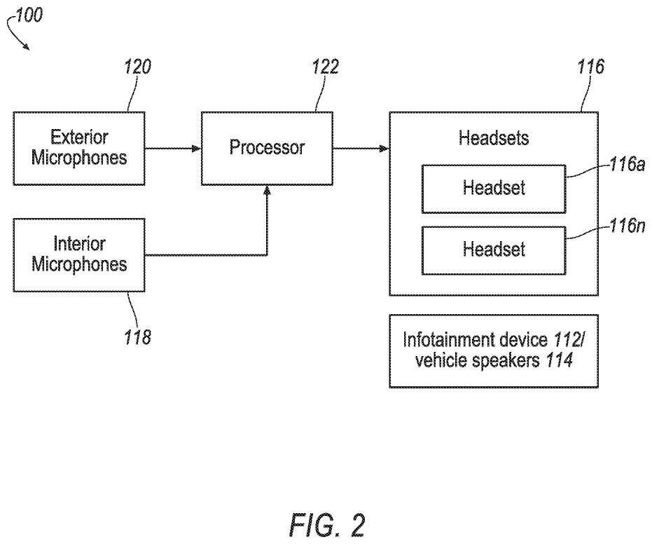

FIG. 1 illustrates an example vehicle audio system 100 for a vehicle 102. The system 100 may include the vehicle 102 and a remote network 106. The vehicle 102 may include a processor 110 arranged within a vehicle. The processor 110 may be included in the vehicle head unit, or a vehicle ECU. The processor 110 may include various vehicle systems such as navigation, infotainment, autonomous vehicle systems, etc. The processor 110 may include an audio system processor 122 (as shown in FIG. 2) configured to determine when and where to audibly play certain audio signals within the vehicle 102. The vehicle processor 110 and/or the audio system processor 122 may each include a controller (not shown) configured to control various vehicle systems and devices. The processors 110, 122 may be interchangeable in that each may handle any of the processes described herein.

The vehicle 102 may include a plurality of internal infotainment devices 112. The infotainment devices 112 may be devices configured to present content to a user, either audibly, visually, haptically, etc., within the vehicle cabin. For example, the infotainment devices 112 may include a vehicle speaker configured to present audible sounds within the vehicle 102. The infotainment devices 112 may include a display or projector configured to visually present information. One or more of these devices may make up the infotainment device 112. For example, the infotainment device 112 may include devices that provide both audio and video information (e.g., both a speaker and a display). Vehicle speakers 114 are shown separately but could be included in the infotainment devices 112. The speakers 114 may emit audible sounds intended to be heard by a driver.

The infotainment devices 112 may present content, such as media content including music, video, etc., to the vehicle occupants. The content may include various forms of infotainment, alerts, etc. In one example, the infotainment devices 112 may present and playback audio content as requested by the vehicle occupants at such as a specific radio station, artist, song, content, etc. In another example, the information may present requested navigation commands as defined by a driving route to a desired destination.

The infotainment devices 112 may be arranged at various locations throughout the vehicle 102. In the example shown in FIG. 1, a first infotainment device 112a is arranged at the vehicle head unit. A second infotainment device 112b and a third infotainment device 112c are arranged on the back headrest and configured to be visible by the rear occupants. These locations are merely exemplary. Furthermore, the infotainment devices 112 may be portable personal devices of each occupant such as the occupants' phone or tablet. The vehicle speakers 114 may also be included in the infotainment devices 112 or function as additional infotainment devices 112. The infotainment devices 112 and the vehicle speakers 114 may be used interchangeably herein and may be primarily configured to provide high quality audio to the vehicle driver. More or less infotainment device 112 may be included in the vehicle.

Each passenger may be associated with a headset 116. The headset 116 may include at least one headphone set configured to be worn by each passenger to allow each passenger to enjoy media content without disturbing the other occupants. The headset 116 may also be configured to selectively emit sounds, such as voices, of other occupants. The headset 116 may be wireless headset connected via wireless communication with a user device. The headset 116 may also be connected with the infotainment device 112 or other user device via a wired connection. The headset 116 may include a microphone configured to acquire noise, such as voices. The processor 110 may control output to each headset 116, including various signal processing, inputs, preferences, etc., to enhance the quality of the audio output. FIG. 1 illustrates a headset associated with each seat position including headsets 116a, 116b, 116c (collective referred to as headsets 116). Notably, a headset is not associated with the driver.

The vehicle 102 may also include a plurality of interior microphones 118a, 118b, 118c, 118d (collectively referred to as interior microphones 118. The interior microphones 118 may be facing the interior of the vehicle 102 and may be configured to acquire ambient noise, voice sounds, and other acoustic events. The interior audio signals acquired by the interior microphones 118 may be transmitted to headsets 116 of the occupants. Approximately one interior microphone 118 may be included for each occupant seat to acquire audio signals from each occupant. The interior microphone 118 may include a microphone array, and more or less microphones may be included. In the example of FIG. 1, a one to one ratio of interior microphones 118 and headsets 116 are illustrated, however, a higher or lower ratio may be appreciated. Further, the microphones 114 may include microphone arrays. Often, such microphones are arranged in the headliner or seatback.

The vehicle 102 may also include a plurality of exterior microphones 120a, 120b, 120c, 120d (collectively referred to as exterior microphones 120) facing exterior of the vehicle 102 and configured to acquire sounds exterior of the vehicle such as emergency vehicle sirens, traffic instructions, and other acoustic events. The exterior microphones 120 may be arranged at various locations around the vehicle 102. In the example shown in FIG. 1, left exterior microphone 120a, front exterior microphone 120b, right exterior microphone 120c, and rear external microphone 120d, may be included. More or less microphones may be included and the position of each in FIG. 1 is an example configuration.

The processor 122 may receive the exterior audio signal from at least one the exterior microphone and determine whether these sounds should be passed through to one or more of the vehicle occupants. For example, if an occupant is listening to music via a headset, specifically the driver, then the processor 122 may determine that a siren from an emergency vehicle should be passed through to the driver and emit the sound via the driver's headset 116a.

Although not shown, the vehicle 102 may include a connected vehicle system including one or more systems facilitated via connected car or connected vehicle telematics. These systems may include features available on a separate mobile device, usually a mobile device of the driver. The processor 110 of the vehicle 102 may communicate wirelessly with the mobile device (not shown) to access data within the mobile device such as the driver's calendar, navigation system, GPS antenna, etc. The data may include data specific and local to the mobile device of the driver such as music, photos, etc. The data may also include dynamic data provided from external sources such as weather information, traffic information, etc. This data may relate to instances typically of interest to the vehicle driver and may indicate to the processor 122 that the information should be passed through to the driver. In addition to or in alternative to the connected vehicle system, the processor 110 may receive data from the network 106, other mobile devices, etc.

FIG. 2 illustrates an example block diagram of the vehicle audio system 100 of FIG. 1. The processor 122 may receive audio signals from the exterior microphones 120 and the interior microphones 118. The processor 122 may determine whether these signals should be passed through to one or more of the vehicle occupants. In one example, the processor 122 may determine whether an exterior audio signal includes an alert such as a siren. If so, then the processor 122 may pass this sound through to the vehicle speakers 114, but not the headsets 116 of the passengers. In another example, the processor 122 may determine that a private conversation is occurring between the driver and the front seat passenger. In this example, the voice signals acquired by the interior microphones 118 may be passed through to first and second headsets 116a, 116b, but not the remaining headsets 116c, 116d. In this example, the rear seat occupants may enjoy their respective media content, uninterrupted.

In yet another example, a parent occupant may select to listen and monitor a conversation between the child occupants. The parent may select, via the infotainment device 112 or HMI, to listen to respective occupants. In this example, sound signals acquired from the interior microphone 118 associate with that occupant may be passed through to the parent headset 116 and/or the driver speakers 114a.

In the example where an occupant elects to listen to the interior audio picked up by the interior microphones 118, the occupant may make such selection at the infotainment device 112, or other device, such as his or her smartphone, tablet, etc. The selection may be made via a touchscreen on either the infotainment device 112, the vehicle display, or the occupant's personal device. In another example, the selection may be made audibly by giving a voice command. For example, the occupant may say “listen in on rear occupant conversation” or “initiate private conversation with the driver.”

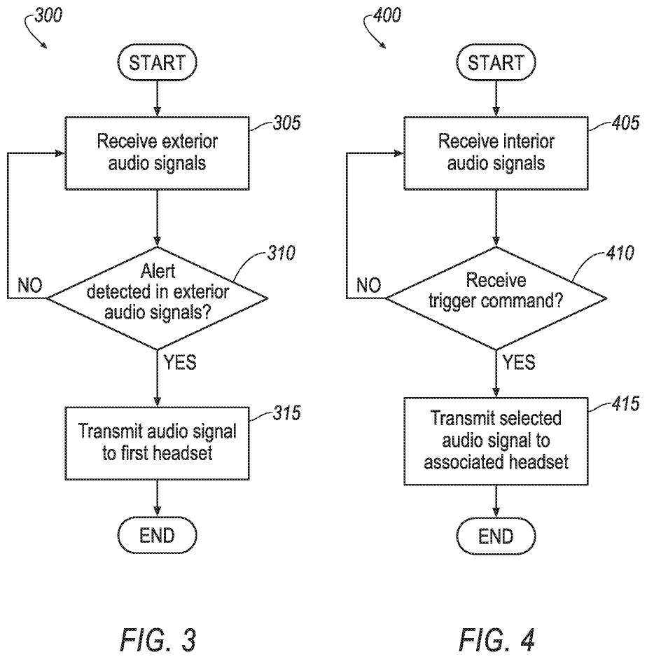

FIG. 3 illustrates an example process 300 for the audio system 100 where an exterior sound may interrupt the driver's current content. The process 300 may begin at block 305 where the processor 122 receives exterior audio signals from the exterior microphones 120.

At block 310, the processor 122 may determine whether the exterior audio signals include an alert. The processor may determine this by analyzing the audio signals for certain alert-like sounds, such as sirens, announcements, etc. A sound may be classified as an alert signal in response to the processor 122 recognizing the sound as that typically heard in an emergency situation. The processor 122 may be in communication with a database of known sounds whereby certain characteristics of the audio signal is compared with characteristics of known alert sounds. Additionally or alternatively, the processor 122 may include a self-learning and adaptive capability to learn certain sounds.

if the processor 122 determines that the exterior audio signals include an alert sound, the process proceeds to block 315. If not, the process 300 proceeds to block 305.

At block 315, the processor 122 may transmit the exterior audio signal to one of the vehicle speakers. In this example, the exterior audio signal may only be transmitted to the driver's vehicle speakers 114 and not to the passengers' headsets 116. The processor 122 may return the vehicle speakers 114 to its normal content once the alert sound is no longer recognized within the exterior audio signals. The process 300 may then end.

FIG. 4 illustrates an example process 400 for the audio system 100 where an interior sound may interrupt one of the occupant's current content. The process 400 may begin at block 405 where the processor 122 receives interior audio signals from the interior microphones 118.

At block 410, the processor 122 may determine whether a trigger command has been received from one of the occupants. The trigger command may include a touch-screen initiated command at the infotainment devices 112 or an audible command recognized by the interior microphones 118. Other forms of trigger commands may also be included, such as audible trigger commands such as trigger words, that when received by the interior microphones 118, may be recognized by the processor 122 as a trigger command. For example, a driver may state “enter conversation mode with front passenger.” If a trigger command has been received, the process 400 proceeds to block 415. If not, the process 400 proceeds to block 405.

At block 415, the processor 122 may transmit the selected audio signal as indicated by the trigger command to the associated headset. That is, if a passenger wishes to have a conversation with the driver, then audio signals detected by the interior microphones 118 associated with the occupant and the driver may be transmitted to the other respective headset to permit conversation to be heard at each headset. The process 400 may then end.

Both process 300 and process 400 may occur simultaneously. The processor 122 may maintain a hierarchy of commands where m some examples, an exterior audio signal including an alert may preempt any commands made by the occupants regarding internal audio signals (e.g., a siren may be transmitted to the driver even if the driver had selected to have a conversation with an occupant.)

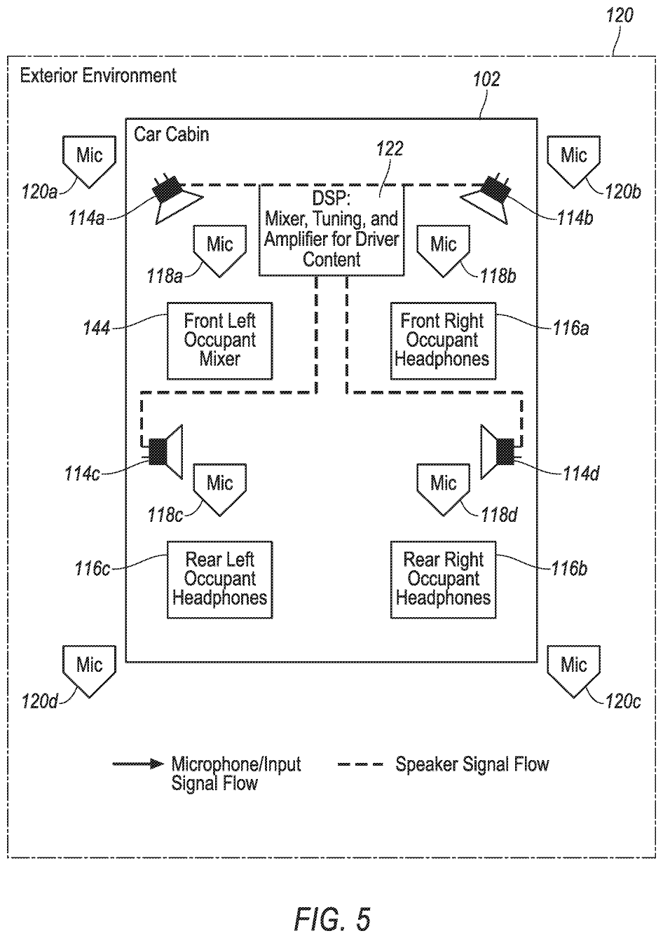

FIG. 5 illustrates an alternative view of the system 100 of FIG. 1. Similar to FIG. 1, a plurality of microphones and speakers are arranged interior and exterior of the vehicle. In this example, the interior speakers 114 are specifically labeled as a first speaker 114a, second speaker 114b, third speaker 114c, and fourth speaker 114d (collectively referred to as speakers 114). The vehicle audio system may use only four channels and four speakers, but this is merely exemplary and other amounts of channels and speakers may be included.

The processor 122 may be a digital signal processor configured to mix, tune, and amplify audio signals and provide the audio signals to the speakers 114 and headsets 116. A front left occupant mixer 144 may be arranged within the vehicle 102. Although shown near the driver's seat, the mixer 144 may be arranged anywhere within the vehicle and may be configured to produce audio signals for the driver's listening experience. For example, the mixer 144 may produce high quality audio signals based on the external audio signal to emit the alert noise to the driver. The mixer 144 may also produce high quality music audio based on active noise cancelation for the driver, at the driver's specific location within the vehicle. Since the other occupants are likely receiving audio signals via their respective headsets 116, the audio signals produced by the vehicle speakers 114 may focus on the driver's location and preferences to produce a driver specific listening experience.

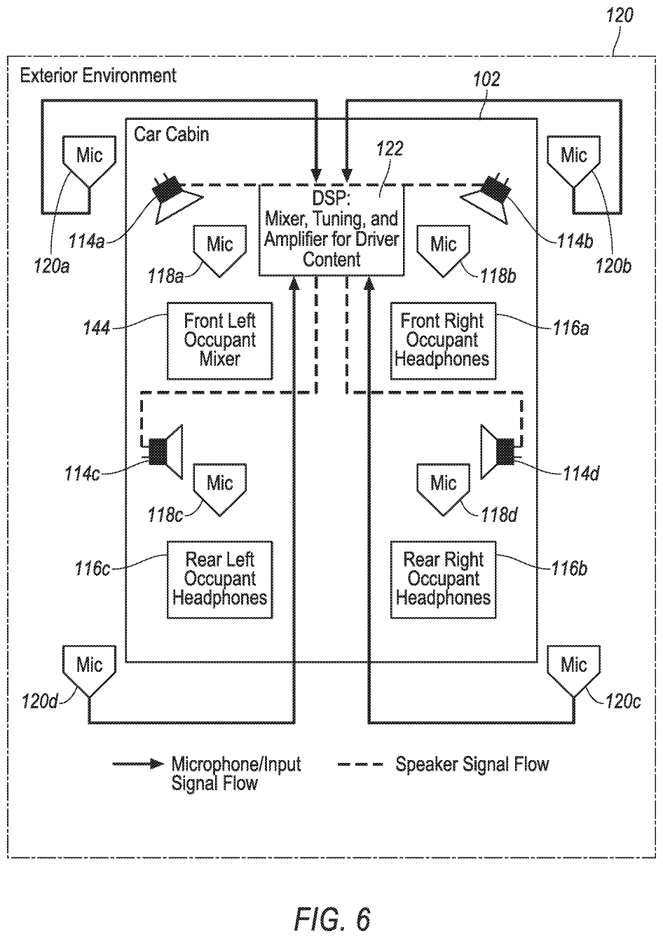

FIG. 6 illustrates an alternative view of the system 100 of FIG. 1. In this view, as well as that of FIG. 5, a mixer is arranged at the position of the front fell occupant, or driver. The remaining occupant positions are associated with headphones. In this example, the driver may receive exterior audio signals including certain alert signals, as described above. The remaining occupants may enjoy their audio signals via the respective headsets 116 without being bothered with the alert signals.

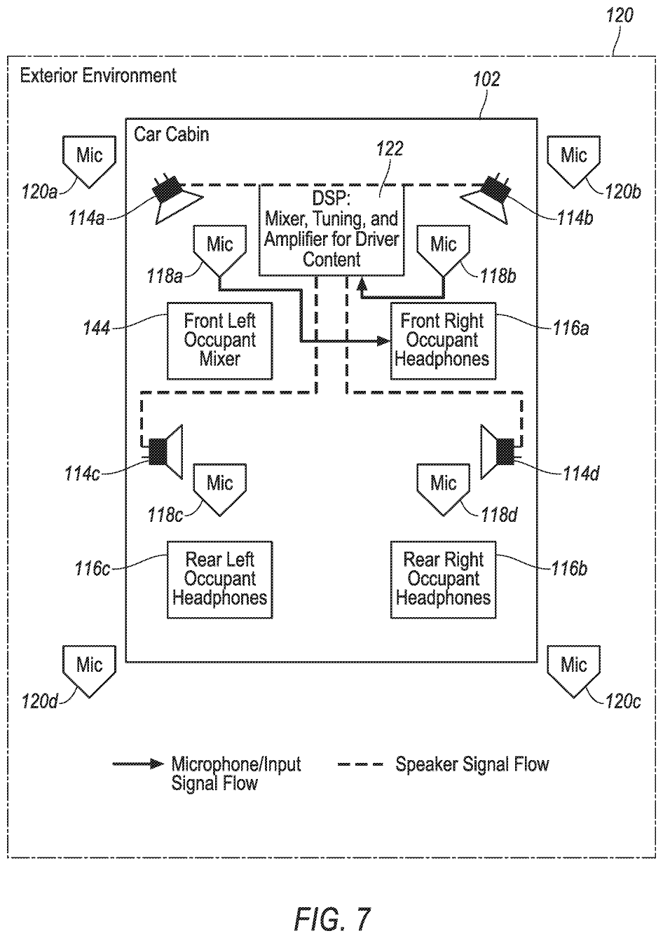

FIG. 7 illustrates an alternative view of the system 100 of FIG. 1. In this view, the driver and front passenger may be engaged in a private conversation. The rear seat occupants may be acoustically isolated. In the example in FIG. 7, the first microphone 118a may pick up audio signal (e.g., voice signals) spoken by the driver. The second microphone 118b may pick up voice signals from the front occupant. The processor 122 may perform digital processing on each signal and transmit the voice signals from the front occupant to the driver speakers 114a, and transmit the voice signals from the driver to the first headset 116a associated with the front occupant. Thus, the front occupant may receive audio relating to the conversation with the driver through his or her headset, while the driver may receive the audio at the vehicle speakers 114. Thus, the front occupants may carry on a conversation, while the rear occupants are acoustically isolated.

Notably, FIGS. 6 and 7 are not mutually exclusive examples. An alert signal may be passed through to the driver via the speakers 114 in the event an alert signal is detected by the exterior microphones 120. That is, the driver's audio or conversation may be interrupted by an incoming alert such as sirens created by emergency vehicles.

Computing devices described herein generally include computer-executable instructions, where the instructions may be executable by one or more computing or hardware devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An in-car audio system, comprising:
at least one interior microphone configured to receive an interior audio signal from within a vehicle cabin;
at least one vehicle speaker arranged in a vehicle cabin and configured to transmit audio signals to a driver;
at least one first headset associated with a first vehicle occupant and configured to transmit audio signals to an associated occupant;
at least one exterior microphone configured to receive an exterior audio signal acquired from outside of the vehicle; and
a processor programmed to:
receive the interior audio signal from the at least one interior microphone and the exterior audio signal from the at least one exterior microphone;
transmit the interior audio signal to the at least one vehicle speaker and to the at least one interior microphone to facilitate a conversation between the driver and at least one occupant;
determine whether the exterior audio signal includes an alert signal; and
cease transmission of the interior audio signal to the vehicle speaker and transmit the alert signal to the vehicle speaker in response to the exterior audio signal including the alert signal.

2. The system of claim 1, wherein the alert signal includes an audible sound relating to an emergency.

3. The system of claim 1, wherein the alert signal includes an audible siren.

4. The system of claim 1, further comprising a second headset associated with a second vehicle occupant.

5. The system of claim 4, wherein the processor is programmed to transmit the interior audio signal to the first and second headsets.

6. The system of claim 1, wherein the processor is further programmed to receive a trigger command, and wherein the first headset includes a plurality of headsets and wherein the trigger command indicates which of the plurality of headsets is to receive the interior audio signal.

7. The system of claim 6, wherein the trigger command is an audible command.

8. An in-car audio system, comprising:
a first headset associated with a first vehicle occupant and configured to transmit audio signals to the first vehicle occupant;
at least one exterior microphone configured to receive an exterior audio signal acquired from outside of the vehicle;
at least one vehicle speaker configured to transmit audio signals; and
a processor programmed to:
transmit interior audio signals acquired from within the vehicle to at least one vehicle speaker;
receive the exterior audio signal from the at least one exterior microphone;
determine whether the exterior audio signal includes an alert signal; and
interrupt the interior audio signals at the vehicle speakers to transmit the exterior audio signal in response to the exterior audio signal including the alert signal.

9. The system of claim 8, wherein the alert signal includes an audible sound relating to an emergency.

10. The system of claim 8, wherein the alert signal includes an audible siren.

11. The system of claim 8, wherein the processor is further programmed to receive a plurality of known alert sounds and compare the exterior audio signal with the known alert sounds to determine whether the exterior audio signal includes an alert signal.

12. The system of claim 8, further comprising at least one second headset associated with a second vehicle occupant distinct from the first vehicle occupant.

13. The system of claim 12, wherein the first headset is associated with a driver of a vehicle and the processor is further programmed to transmit the exterior audio signal only to the first headset associated with the driver and not to the at least one second headset.

14. An in-car audio method, comprising:
receiving an interior audio signal from at least one interior microphone;
receiving at least one trigger command including an identification of which of a subset of a plurality of headsets and speakers to transmit the interior audio signal to, each of the headsets and speakers associated with a vehicle occupant; and
transmitting the interior audio signal to the subset of headsets and speakers in response to the trigger command, wherein at least one of the subset of headset and speakers is an in-vehicle speaker.

15. The method of claim 14, wherein the trigger command includes a command received via a human machine interface (HMI).

16. The method of claim 14, wherein the trigger command is an audible command.

17. The method of claim 14, wherein the interior audio signal includes human voice signals acquired from the at least one interior microphone.

18. The method of claim 14, further comprising continuously transmitting media signals to the other headsets not included in the subset of headsets.

19. The method of claim 15, wherein the trigger command identifies a subset of occupants to receive the interior audio signal.
